(19) United States
(12) Patent Application Publication
(10) Pub. No.: US 2013/0325554 A1
(43) Pub. Date: Dec. 5, 2013

(54) Commerce System and Method of Optimizing Profit for Retailer from Price Elasticity of Other Retailers

(71) Applicant: Kenneth J. Ouimet, Scottsdale, AZ (US)

(72) Inventor: Kenneth J. Ouimet, Scottsdale, AZ (US)

(73) Assignee: MYWORLD, INC., Scottsdale, AZ (US)

(21) Appl. No.: 13/486,965

(22) Filed: Jun. 1, 2012

(51) Int. Cl. G06Q 30/02

(52) U.S. Cl. 705/7.35

(57) ABSTRACT

A commerce system has retailers offering products for sale to consumers. Product information is collected from retailers. A price elasticity of demand is determined for a first product from a first retailer. An estimated price elasticity of demand is determined for a second product for a second retailer based on the price elasticity of demand from the first retailer. The estimated price elasticity of demand is substantially equal to the price elasticity of demand. A price is determined for the second product for the second retailer based on the estimated price elasticity. A profit for the second product is optimized for the second retailer by selecting the price for the second product based on the estimated price elasticity. The commerce system is controlled by enabling the second retailer to select the price for the second product based on the estimated price elasticity.

### FIELD OF THE INVENTION

The present invention relates in general to consumer purchasing and, more particularly, to a commerce system and method of optimizing profit for a retailer based on price elasticity of other retailers.

### BACKGROUND OF THE INVENTION

Economic and financial modeling and planning is commonly used to estimate or predict the performance and outcome of real systems, given specific sets of input data of interest. An economic-based system will have many variables and influences which determine its behavior. A model is a mathematical expression or representation which predicts the outcome or behavior of the system under a variety of conditions. In one sense, it is relatively easy to review historical data, understand its past performance, and state with relative certainty that past behavior of the system was indeed driven by the historical data. A more difficult task is to generate a mathematical model of the system which predicts how the system will behave with different sets of data and assumptions.

In its basic form, the economic model can be viewed as a predicted or anticipated outcome of a system defined by a mathematical expression and driven by a given set of input data and assumptions. The mathematical expression is formulated or derived from principles of probability and statistics, often by analyzing historical data and corresponding known outcomes, to achieve a best fit of the expected behavior of the system to other sets of data. In other words, the model should be able to predict the outcome or response of the system to a specific set of data being considered or proposed, within a level of confidence, or an acceptable level of uncertainty.

Economic modeling has many uses and applications. One area in which modeling has been applied is in the retail environment. Grocery stores, general merchandise stores, specialty shops, and other retail outlets face stiff competition for limited consumers and business. In the face of mounting competition and high expectations from investors, retailers must look for every advantage they can muster in maximizing market share, sales, revenue, and profit. Economic modeling can be an effective tool in helping store owners and managers forecast and optimize business decisions. The retailer operates under a business plan to set pricing, order inventory, formulate and run promotions, add and remove product lines, organize product shelving and displays, select signage, hire employees, expand stores, collect and maintain historical sales data, evaluate performance and trends, and make strategic decisions. Based on economic modeling, the retailer can change the business plan as needed.

Profit can be expressed as unit sales of products times price less cost per unit of product, i.e., US*(P−C). Costs are typically fixed or at least predictable in terms of inventory, raw materials, labor, facilities, equipment, taxes, and other overhead expenses. For the retailer to maximize profit, the relationship between unit sales (demand) and price must be well understood. In most cases, price is inversely related to demand. As price increases, demand decreases; as price decreases, demand increases. Price elasticity of demand is a unitless measure of response in demand to changes in price, i.e., a ratio of the percent change in demand to the percent change in price.

An accurate measure of price elasticity of demand typically requires processing of a large amount of price and demand data over a long period of time (multiple seasons). Price elasticity of demand often depends on the local market. The price elasticity of demand in one market does not necessarily track price elasticity of demand in a different market, either in terms of geography or business model (products offered for sale). If a retailer opens a store in a new area, or begins to carry a new product line in an existing store, then price and demand data for that retailer in the subject local market is limited. At least in the short term, the retailer will have difficulty in determining price elasticity of demand and maximizing profit for the local market.

In a highly competitive market, the profit margin is paper-thin and consumer loyalty is at a premium. Retailers must understand and act in tune with the local market to make effective use of marketing dollars. The retailers remain motivated to optimize marketing strategy, particularly pricing strategy, to maximize revenue and profit.

### SUMMARY OF THE INVENTION

A need exists for retailers to build market share and increase sales and revenue in a manner that maximizes profit. Accordingly, in one embodiment, the present invention is a method of controlling a commerce system comprising the steps of collecting product information from a plurality of retailers associated with a plurality of products, storing the product information in a database, determining a first price elasticity of demand for a first product from a first retailer, determining an estimated price elasticity of demand for a second product for a second retailer based on the first price elasticity of demand from the first retailer, determining a price for the second product for the second retailer based on the estimated price elasticity of demand, and controlling the commerce system by enabling the second retailer to select the price for the second product based on the estimated price elasticity of demand.

In another embodiment, the present invention is a method of controlling a commerce system comprising the steps of collecting product information associated with a plurality of products, determining a first price elasticity for a first product from a first member of the commerce system, determining an estimated price elasticity for a second product for a second member of the commerce system based on the first price elasticity from the first member, and determining a price for the second product for the second member based on the estimated price elasticity.

In another embodiment, the present invention is a method of controlling a commerce system comprising the steps of determining a first price elasticity for a first product from a first member of the commerce system, and determining an estimated price elasticity for a second product for a second member of the commerce system based on the first price elasticity from the first member.

In another embodiment, the present invention is a computer program product usable with a programmable computer processor having a computer readable program code embodied in a tangible computer usable medium for controlling a commerce system comprising the steps of determining a first price elasticity for a first product from a first member of the commerce system, and determining an estimated price elasticity for a second product for a second member of the commerce system based on the first price elasticity from the first member.

### BRIEF DESCRIPTION OF THE DRAWINGS

FIG. 1 illustrates a retailer engaged in commercial activity with a consumer;

FIG. 2 illustrates a commercial system with a manufacturer, distributor, retailer, and consumer;

FIG. 3 illustrates commercial transactions between consumers and retailers with the aid of a retailer service provider;

FIG. 4 illustrates an electronic communication network between members of the commerce system;

FIG. 5 illustrates a computer system operating with the electronic communication network;

FIG. 6 illustrates a consumer profile registration webpage with the retailer service provider;

FIG. 7 illustrates a consumer login webpage for the retailer service provider;

FIG. 8 illustrates a webpage with preference levels for product attributes defined by the consumer and entered into a personal assistant engine;

FIG. 9 illustrates commercial interaction between the consumers, retailers, and retailer service provider to generate a shopping list with discount offers;

FIG. 10 illustrates collecting product information from retailer websites directly by the retailer service provider or indirectly using consumer computers;

FIG. 11 illustrates a curve of price versus demand;

FIG. 12 illustrates a plurality of retailers operating within a local market;

FIG. 13 illustrates determining price elasticity of demand for retailers within the local market; and

FIG. 14 illustrates the process of controlling the commerce system by enabling a retailer to select a price for a product based on an estimated price elasticity of demand.

### DETAILED DESCRIPTION OF THE DRAWINGS

The present invention is described in one or more embodiments in the following description with reference to the figures, in which like numerals represent the same or similar elements. While the invention is described in terms of the best mode for achieving the invention's objectives, it will be appreciated by those skilled in the art that it is intended to cover alternatives, modifications, and equivalents as may be included within the spirit and scope of the invention as defined by the appended claims and their equivalents as supported by the following disclosure and drawings.

Economic and financial modeling and planning are important business tools that allow companies to conduct business planning, forecast demand, and optimize prices and promotions to meet profit and/or revenue goals. Economic modeling is applicable to many businesses, such as manufacturing, distribution, wholesale, retail, medicine, chemicals, financial markets, investing, exchange rates, inflation rates, pricing of options, value of risk, research and development, and the like.

In the face of mounting competition and high expectations from investors, most, if not all, businesses must look for every advantage they can muster in maximizing market share and profits. The ability to forecast demand, in view of pricing and promotional alternatives, and to consider other factors which materially affect overall revenue and profitability is vital to the success of the bottom line, and the fundamental need to not only survive but to prosper and grow.

In particular, economic modeling is essential to businesses that face thin profit margins, such as general consumer merchandise and other retail outlets. Many businesses are interested in economic modeling and forecasting, particularly when the model provides a high degree of accuracy or confidence. Such information is a powerful tool and highly valuable to the business. While the present discussion will involve a retailer, it is understood that the system described herein is applicable to data analysis for other members in the chain of commerce, or other industries and businesses having similar goals, constraints, and needs.

A retailer routinely collects T-LOG sales data for most if not all products in the normal course of business. Using the T-LOG data, the system generates a demand model for one or more products at one or more stores. The model is based upon the T-LOG data for that product and includes a plurality of parameters. The values of the parameters define the demand model and can be used for making predictions about the future sales activity for the product. For example, the model for each product can be used to predict future demand or sales of the product at that store in response to a proposed price, associated promotions or advertising, as well as impact from holidays and local seasonal variations. Promotion and advertising increase consumer awareness of the product.

An economic demand model analyzes historical retail T-LOG sales data to gain an understanding of retail demand as a function of factors such as price, promotion, time, consumer, seasonal trends, holidays, and other attributes of the transaction. The demand model can be used to forecast future demand by consumers as measured by unit sales. Unit sales are typically inversely related to price, i.e., the lower the price, the higher the sales. The quality of the demand model—and therefore the forecast quality—is directly affected by the quantity, composition, and accuracy of historical T-LOG sales data provided to the model.

The retailer makes business decisions based on forecasts. The retailer orders stock for replenishment purposes and selects items for promotion or price discount. To support good decisions, it is important to quantify the quality of each forecast. The retailer can then review any actions to be taken based on the accuracy of the forecasts on a case-by-case basis.

Referring to FIG. 1, retailer 10 has certain product lines or services available to consumers as part of its business plan 12. The terms products and services are interchangeable in the commercial system. Retailer 10 can be a food store chain, general consumer product retailer, drug store, discount warehouse, department store, apparel store, specialty store, or service provider. Retailer 10 has the ability to set pricing, order inventory, run promotions, arrange its product displays, collect and maintain historical sales data, and adjust its strategic business plan.

Business plan 12 includes planning 12a, forecasting 12b, and optimization 12c steps and operations. Business plan 12 gives retailer 10 the ability to evaluate performance and trends, make strategic decisions, set pricing, order inventory, formulate and run promotions, hire employees, expand stores, add and remove product lines, organize product shelving and displays, select signage, and the like. Business plan 12 allows retailer 10 to analyze data, evaluate alternatives, run forecasts, and make decisions to control its operations. With input from the planning 12a, forecasting 12b, and optimization 12c steps and operations of business plan 12, retailer 10 undertakes various purchasing or replenishment operations 14. Retailer 10 can change business plan 12 as needed.

Retailer 10 routinely enters into sales transactions with customer or consumer 16. In fact, retailer 10 maintains and updates its business plan 12 to increase the number of transactions (and thus revenue and/or profit) between retailer 10 and consumer 16. Consumer 16 can be a specific individual, account, or business entity.

For each sales transaction entered into between retailer 10 and consumer 16, information describing the transaction is stored in T-LOG 20. When a consumer goes through the check-out at a grocery or any other retail store, each of the items to be purchased is scanned and data is collected and stored by a point-of-sale (POS) system, or other suitable data collection and storage system, in T-LOG 20. The data includes the then current price, promotion, and merchandizing information associated with the product along with the units purchased, and the dollar sales. The date and time, and store and consumer information corresponding to that purchase are also recorded.

T-LOG data 20 contains one or more line items for each retail transaction, such as those shown in Table 1. Each line item includes information or attributes relating to the transaction, such as store number, product number, time of transaction, transaction number, quantity, current price, profit, promotion number, and consumer identity or type number. The store number identifies a specific store; product number identifies a product; time of transaction includes date and time of day; quantity is the number of units of the product; current price (in US dollars) can be the regular price, reduced price, or higher price in some circumstances; profit is the difference between current price and cost of selling the item; promotion number identifies any promotion associated with the product, e.g., flyer, ad, discounted offer, sale price, coupon, rebate, end-cap, etc.; consumer identifies the consumer by type, class, region, demographics, or individual, e.g., discount card holder, government sponsored or under-privileged, volume purchaser, corporate entity, preferred consumer, or special member. T-LOG data 20 is accurate, observable, and granular product information based on actual retail transactions within the store. T-LOG data 20 represents the known and observable results from the consumer buying decision or process. T-LOG data 20 may contain thousands of transactions for retailer 10 per store per day, or millions of transactions per chain of stores per day.

TABLE 1
T-LOG Data

| STORE | PRODUCT | TIME | TRANS | QTY | PRICE | PROFIT | PROMOTION | CONSUMER |
|---|---|---|---|---|---|---|---|---|
| S1 | P1 | D1 | T1 | 1 | 1.50 | 0.20 | PROMO1 | C1 |
| S1 | P2 | D1 | T1 | 2 | 0.60 | 0.05 | PROMO2 | C1 |
| S1 | P3 | D1 | T1 | 3 | 3.00 | 0.40 | PROMO3 | C1 |
| S1 | P4 | D1 | T2 | 4 | 1.60 | 0.50 | 0 | C2 |
| S1 | P5 | D1 | T2 | 1 | 2.25 | 0.60 | 0 | C2 |
| S1 | P6 | D1 | T3 | 10 | 2.65 | 0.55 | PROMO4 | C3 |
| S1 | P1 | D2 | T4 | 5 | 1.50 | 0.20 | PROMO1 | C4 |
| S2 | P7 | D3 | T5 | 1 | 5.00 | 1.10 | PROMO5 | C5 |
| S2 | P1 | D3 | T6 | 2 | 1.50 | 0.20 | PROMO1 | C6 |
| S2 | P8 | D3 | T6 | 1 | 3.30 | 0.65 | 0 | C6 |

The first line item shows that on day/time D1, store S1 has transaction T1 in which consumer C1 purchases one product P1 at $1.50. The next two line items also refer to transaction T1 and day/time D1, in which consumer C1 also purchases two products P2 at $0.60 each and three products P3 at price $3.00 each. In transaction T2 on day/time D1, consumer C2 has four products P4 at price $1.60 each and one product P5 at price $2.25. In transaction T3 on day/time D1, consumer C3 has ten products P6 at $2.65 each in his or her basket. In transaction T4 on day/time D2 (different day and time) in store S1, consumer C4 purchases five products P1 at price $1.50 each. In store S2, transaction T5 with consumer C5 on day/time D3 (different day and time) involves one product P7 at price $5.00. In store S2, transaction T6 with consumer C6 on day/time D3 involves two products P1 at price $1.50 each and one product P8 at price $3.30.

Table 1 further shows that product P1 in transaction T1 has promotion PROMO1. PROMO1 can be any suitable product promotion such as a front-page featured item in a local advertising flyer. Product P2 in transaction T1 has promotion PROMO2 as an end-cap display in store S1. Product P3 in transaction T1 has promotion PROMO3 as a reduced sale price with a discounted offer. Product P4 in transaction T2 on day/time D1 has no promotional offering. Likewise, product P5 in transaction T2 has no promotional offering. Product P6 in transaction T3 on day/time D1 has promotion PROMO4 as a volume discount for 10 or more items. Product P7 in transaction T5 on day/time D3 has promotion PROMO5 as a $0.50 rebate. Product P8 in transaction T6 has no promotional offering. A promotion may also be classified as a combination of promotions, e.g., flyer with sale price, end-cap with rebate, or discounted offer as described below.

Retailer 10 may also provide additional information to T-LOG data 20 such as promotional calendar and events, holidays, seasonality, store set-up, shelf location, end-cap displays, flyers, and advertisements. The information associated with a flyer distribution, e.g., publication medium, run dates, distribution, product location within flyer, and advertised prices, is stored within T-LOG data 20.

Supply data 22 is also collected and recorded from manufacturers and distributors. Supply data 22 includes inventory or quantity of products available at each location in the chain of commerce, i.e., manufacturer, distributor, and retailer. Supply data 22 includes product on the store shelf and replenishment product in the retailer's storage area.

With T-LOG 20 and supply data 22 collected, various suitable methods or algorithms can be used to analyze the data and form demand model 24. Model 24 may use a combination of linear, nonlinear, deterministic, stochastic, static, or dynamic equations or models for analyzing T-LOG 20 or aggregated T-LOG data and supply data 22 and making predictions about consumer behavior to future transactions for a particular product at a particular store, or across entire product lines for all stores. Model 24 is defined by a plurality of parameters and can be used to generate unit sales forecasting, price optimization, promotion optimization, markdown/clearance optimization, assortment optimization, merchandize and assortment planning, seasonal and holiday variance, and replenishment optimization. Model 24 has a suitable output and reporting system that enables the output from model 24 to be retrieved and analyzed for updating business plan 12.

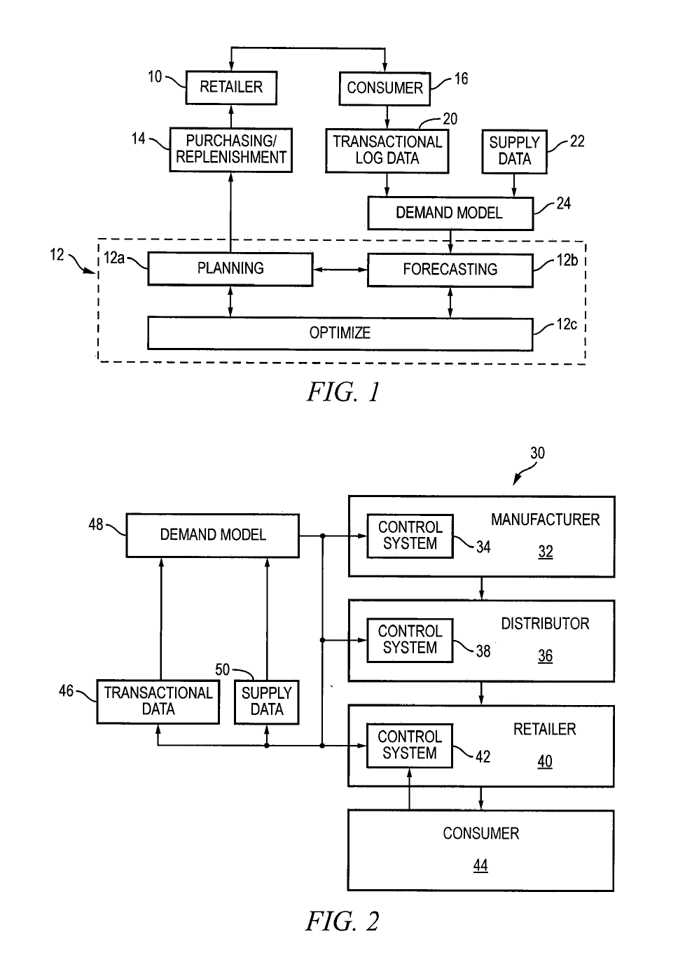

In FIG. 2, a commerce system 30 is shown involving the movement of goods between members of the system. Manufacturer 32 produces goods in commerce system 30. Manufacturer 32 uses control system 34 to receive orders, control manufacturing and inventory, and schedule deliveries. Distributor 36 receives goods from manufacturer 32 for distribution within commerce system 30. Distributor 36 uses control system 38 to receive orders, control inventory, and schedule deliveries. Retailer 40 receives goods from distributor 36 for sale within commerce system 30. Retailer 40 uses control system 42 to place orders, control inventory, and schedule deliveries with distributor 36. Retailer 40 sells goods to consumer 44. Consumer 44 patronizes retailer's establishment either in person or using online ordering. The consumer purchases are entered into control system 42 of retailer 40 as T-LOG data 46.

The purchasing decisions made by consumer 44 drive the manufacturing, distribution, and retail portions of commerce system 30. More purchasing decisions made by consumer 44 for retailer 40 lead to more merchandise movement for all members of commerce system 30. Manufacturer 32, distributor 36, and retailer 40 utilize demand model 48 (similar to model 24), via respective control systems 34, 38, and 42, to control and optimize the ordering, manufacturing, distribution, sale of the goods, and otherwise execute respective business plan 12 within commerce system 30 in accordance with the purchasing decisions made by consumer 44.

Manufacturer 32, distributor 36, and retailer 40 provide historical T-LOG 46 and supply data 50 to demand model 48 by electronic communication link, which in turn generates forecasts to predict the need for goods by each member and control its operations. In one embodiment, each member provides its own historical T-LOG data 46 and supply data 50 to demand model 48 to generate a forecast of demand specific to its business plan 12. Alternatively, all members can provide historical T-LOG data 46 and supply data 50 to demand model 48 to generate composite forecasts relevant to the overall flow of goods. For example, manufacturer 32 may consider a proposed discounted offer, rebate, promotion, seasonality, or other attribute for one or more goods that it produces. Demand model 48 generates the forecast of sales based on available supply and the proposed price, consumer, rebate, promotion, time, seasonality, or other attribute of the goods. The forecast is communicated to control system 34 by electronic communication link, which in turn controls the manufacturing process and delivery schedule of manufacturer 32 to send goods to distributor 36 based on the predicted demand ultimately determined by the consumer purchasing decisions. Likewise, distributor 36 or retailer 40 may consider a proposed discounted offer, rebate, promotion, or other attributes for one or more goods that it sells. Demand model 48 generates the forecast of demand based on the available supply and proposed price, consumer, rebate, promotion, time, seasonality, and/or other attribute of the goods. The forecast is communicated to control system 38 or control system 42 by electronic communication link, which in turn controls ordering, distribution, inventory, and delivery schedule for distributor 36 and retailer 40 to meet the predicted demand for goods in accordance with the forecast.

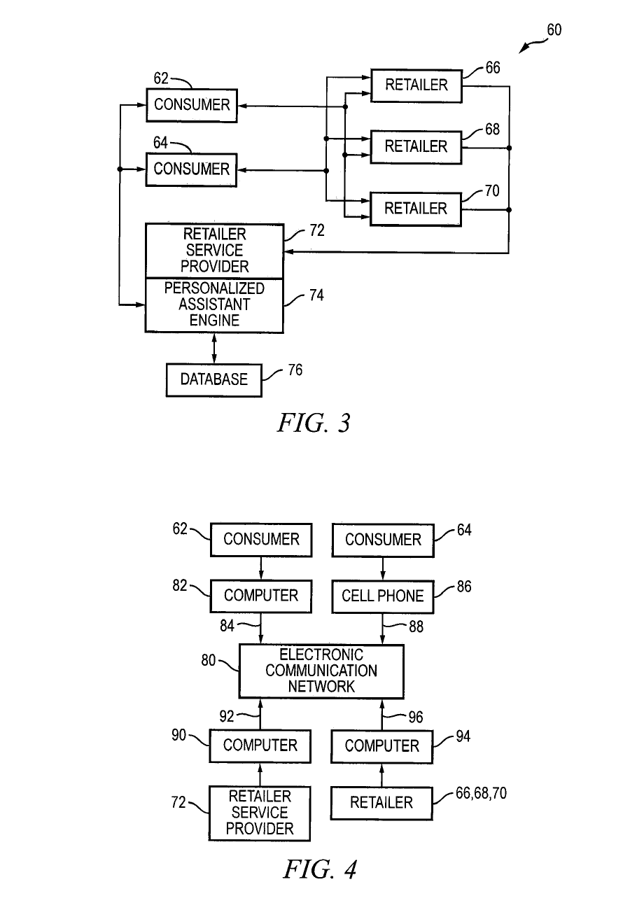

FIG. 3 illustrates a commerce system 60 with consumers 62 and 64 engaged in purchasing transactions with retailers 66, 68, and 70. Retailers 66-70 are supplied by manufacturers and distributors, as described in FIG. 2. Retailers 66-70 are typically local to consumers 62-64, i.e., retailers that the consumers will likely patronize. Retailers 66-70 can also be remote from consumers 62-64 with transactions handled by electronic communication medium, e.g., phone or online website via personal computer, and delivered electronically or by common carrier, depending on the nature of the goods. Consumers 62-64 patronize retailers 66-70 by selecting one or more items for purchase from one or more retailers. For example, consumer 62 can visit the store of retailer 66 in person and select product P1 for purchase. Consumer 62 can contact retailer 68 by phone or email and select product P2 for purchase. Consumer 64 can browse the website of retailer 70 using a personal computer and select product P3 for purchase. Accordingly, consumers 62-64 and retailers 66-70 regularly engage in commercial transactions within commerce system 60.

As described herein, manufacturer 32, distributor 36, retailers 66-70, consumers 62-64, and retailer service provider 72 are considered members of commerce system 60. The retailer generally refers to the seller of the product and consumer generally refers to the buyer of the product. Depending on the transaction within commerce system 60, manufacturer 32 can be the seller and distributor 36 can be the buyer, or distributor 36 can be the seller and retailers 66-70 can be the buyer, or manufacturer 32 can be the seller and consumers 62-64 can be the buyer.

A retailer service provider 72 is a part of commerce system 60. Retailer service provider 72 is a third party that assists consumers 62-64 with the product evaluation and purchasing decision process by providing access to a comparative shopping service. More specifically, retailer service provider 72 operates and maintains personal assistant engine 74 that prioritizes product attributes and optimizes product selection according to consumer-weighted preferences. The product attributes and consumer-weighted preferences are stored in database 76. In addition, personal assistant engine 74 generates a discounted offer for a product to entice a positive purchasing decision by a specific consumer. Personal assistant engine 74 saves the consumer considerable time and money by providing access to a comprehensive, reliable, and objective comparative shopping service.

Each consumer goes through a product evaluation and purchasing decision process each time a particular product is selected for purchase. Some product evaluations and purchasing decision processes are simple and routine. For example, when consumer 62 is conducting weekly shopping in the grocery store, the consumer considers a needed item or item of interest, e.g., canned soup. Consumer 62 may have a preferred brand, size, and flavor of canned soup. Consumer 62 selects the preferred brand, size, and flavor sometimes without consideration of price, places the item in the basket, and moves on. The product evaluation and purchasing decision process can be almost automatic and instantaneous but nonetheless still occurs based on prior experiences and preferences. Consumer 62 may pause during the product evaluation and purchasing decision process and consider other canned soup options. Consumer 62 may want to try a different flavor or another brand offering a lower price. As the price of the product increases, the product evaluation and purchasing decision process usually becomes more involved. If consumer 62 is shopping for a major appliance, the product evaluation and purchasing decision process may include consideration of several manufacturers, visits to multiple retailers, review of features and warranty, talking to salespersons, reading consumer reviews, and comparing prices. In any case, understanding the consumer's approach to the product evaluation and purchasing decision process is part of an effective comparative shopping service. The comparative shopping service assists the consumer in finding the optimal price and product attributes, e.g., brand, quality, quantity, size, features, ingredients, service, warranty, and convenience, that are important to the consumer and tip the purchasing decision toward selecting a particular product and retailer.

Personal assistant engine 74 can be made available to consumers 62-64 via computer-based online website or other electronic communication medium, e.g., wireless cell phone or other personal communication device. FIG. 4 shows an electronic communication network 80 for transmitting information between consumers 62-64, retailer service provider 72, and retailers 66-70. Consumer 62 operating with computer 82 is connected to electronic communication network 80 by way of communication channel or link 84. Likewise, consumer 64 operating with a cellular telephone, smart phone, or other wireless communication device 86, is connected to electronic communication network 80 by way of communication channel or link 88. Retailer service provider 72 uses computer 90 to communicate with electronic communication network 80 over communication channel or link 92. Retailers 66-70 use computer 94 to communicate with electronic communication network 80 over communication channel or link 96. The electronic communication network 80 is a distributed network of interconnected routers, gateways, switches, and servers, each with a unique internet protocol (IP) address to enable communication between individual computers, cellular telephones, electronic devices, or nodes within the network. In one embodiment, electronic communication network 80 is a cell phone service network. Alternatively, communication network 80 is a global, open-architecture network, commonly known as the Internet. Communication channels 84, 88, 92, and 96 are bi-directional and transmit data between computers 82, 90, and 94 and cell phone 86 and electronic communication network 80 in a hard-wired or wireless configuration. For example, computers 82, 90, and 94 have email, texting, and Internet capability, and consumer cell phone 86 has email, mobile applications (apps), texting, and Internet capability.

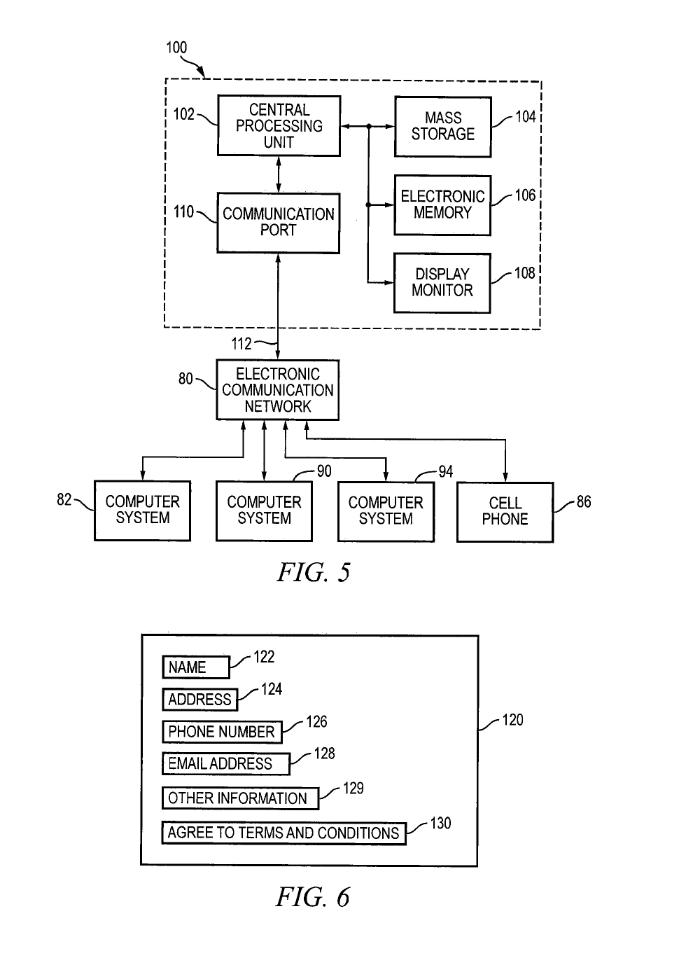

Further detail of the computer systems used in electronic communication network 80 is shown in FIG. 5 as a simplified computer system 100 for executing the software program used in the electronic communication process. Computer system 100 is a general purpose computer including a processing unit or microprocessor 102, mass storage device or hard disk 104, electronic memory 106, display monitor 108, and communication port 110. Communication port 110 represents a modem, high-speed Ethernet link, wireless, or other electronic connection to transmit and receive input/output (I/O) data over communication link 112 to electronic communication network 80. Computer system or server 82, 90, and 94 can be configured as shown for computer 100. Computer system 82, 90, 94, and 100 and cell phone 86 transmit and receive information and data over communication network 80.

Computer systems 82, 90, 94, and 100 can be physically located in any location with access to a modem or communication link to network 80. For example, computer 82, 90, 94, and 100 can be located in a home or business office. Retailer service provider 72 may use computer system 82, 90, 94, or 100 in its business office. Alternatively, computer 82, 90, 94, and 100 can be mobile and follow the user to any convenient location, e.g., remote offices, consumer locations, hotel rooms, residences, vehicles, public places, or other locales with electronic access to electronic communication network 80. The consumer can access electronic communication network 80 by mobile app operating in cell phone 86.

Each of the computers runs application software and computer programs, which can be used to display user interface screens, execute the functionality, and provide the electronic communication features as described below. The application software includes an Internet browser, local email application, mobile apps, word processor, spreadsheet, and the like. In one embodiment, the screens and functionality come from the application software, i.e., the electronic communication runs directly on computer system 82, 90, 94, and 100. Alternatively, the screens and functions are provided remotely from one or more websites on servers within electronic communication network 80.

The software is originally provided on computer readable media, such as compact disks (CDs), external drive, or other mass storage medium. Alternatively, the software is downloaded from electronic links, such as the host or vendor website. The software is installed onto the computer system hard drive 104 and/or electronic memory 106, and is accessed and controlled by the computer operating system. Software updates are also electronically available on mass storage medium or downloadable from the host or vendor website. The software, as provided on the computer readable media or downloaded from electronic links, represents a computer program product containing computer readable program code embodied in a computer program medium. Computers 82, 90, 94, and 100 run application software to execute instructions for communication between consumers 62 and 64 and retailer service provider 72 to perform the functions described herein. Cell phone 86 runs one or more mobile apps to execute instructions for communication between consumers 62 and 64 and retailer service provider 72. The application software is an integral part of the control of commercial activity within commerce system 60.

To interact with retailer service provider 72, consumers 62 and 64 first create an account and profile with the retailer service provider by electronic links 84 and 88. Consumers 62 and 64 can use some features offered by retailer service provider 72 without creating an account, but full access requires completion of a registration process. The consumer accesses website 120 operated by retailer service provider 72 on computer systems 82, 90, 94, or 100 and provides data to complete the registration and activation process, as shown in FIG. 6. The consumer can access website 120 using cell phone 86 or computer systems 82, 90, 94, or 100 by typing the uniform resource locator (URL) for website 120, or by clicking on a banner located on another website which re-directs the consumer to a predetermined landing page for website 120. The data provided by the consumer to retailer service provider 72 may include name in block 122, home address and work address with zip code in block 124, phone number in block 126, email address in block 128, and other information and credentials in block 129 necessary to establish a profile, identity, and general preferences for the consumer. The consumer's home and work address and zip code are important as shopping is often a local activity. The consumer agrees to the terms and conditions of conducting electronic communication through retailer service provider 72 in block 130.

The profile can also contain information related to the shopping habits and preferences of consumers 62-64. For example, the other information in block 129 includes product preferences, consumer characteristics, and consumer demographics, e.g., gender, age, family size, age of children, occupation, medical conditions, shopping budget, and general product preferences (low fat, high fiber, vegetarian, natural with no preservatives, biodegradable, convenience of preparation or use, name brand, generic brands, kosher). Consumers 62-64 can specify preferred retailers and spending patterns. Alternatively, retailers 66-70 can provide T-LOG data 46 to retailer service provider 72 to accurately track the shopping patterns of consumers 62-64. Consumer surface provider 72 will have records of consumer loyalty and value to each retailer. Consumer value is based on spending patterns of the consumer.

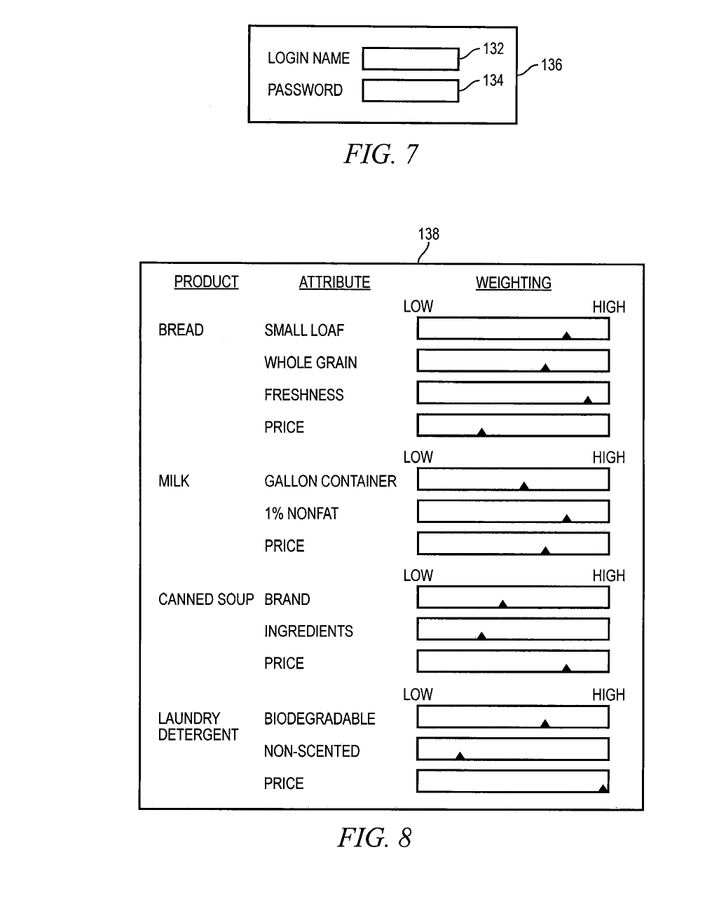

The consumer's profile is stored and maintained within database 76. The consumer can access and update his or her profile or interact by entering login name 132 and password 134 in webpage 136, as shown in FIG. 7. The consumer name can be any personal name, user name, number, or email address that uniquely identifies the consumer and the password can be assigned to or selected by the consumer. Accordingly, the consumer's profile and personal data remain secure and confidential within database 76 by retailer service provider 72.

Once logged-in to retailer service provider 72, consumers 62 and 64 utilize personal assistant engine 74 to assist with the shopping process. More specifically, consumers 62 and 64 provide commonly purchased products or anticipated purchase products through webpage 138, as shown in FIG. 8. Each product will have product attributes weighted by consumer preference. Webpage 138 can display a list of available product attributes associated with each product category. The available product attributes can be product-specific attributes, diet/health/nutrient related product attributes, lifestyle related product attributes, environment related product attributes, allergen related product attributes, and social/society related product attributes. The product-specific attributes can include brand, ingredients, size, price, freshness, warranty, and the like. The consumer defines the products, adds one or more product attributes, and assigns weighted preferences with a sliding scale from 0 (lowest importance) to 9 (highest importance). For example, the consumer may define the products of interest as bread, milk, canned soup, and laundry detergent. The consumer adds product attributes for each product and, using a sliding scale, assigns a preference level for each product attribute, as shown in webpage 138. The sliding scale adjusts the preference level of the product attribute by dragging a pointer along the length of the sliding scale. In the present example, the consumer preference levels for bread attributes are 7 for small loaf, 6 for whole grain, 8 for freshness, and 3 for price. The consumer preference levels for milk attributes are 5 for gallon container, 7 for 1% low fat, and 6 for price. The consumer preference levels for canned soup attributes are 4 for brand, 3 for product ingredients, and 7 for price. The consumer preference levels for laundry detergent attributes are 6 for biodegradable, 2 for non-scented, and 9 for price.

The consumer can also identify a specific preferred retailer as an attribute with an assigned preference level based on convenience and personal experience. The consumer may assign value to shopping with a specific retailer because of specific products offered by that store, familiarity with the store layout, good retailer service experiences, or location that is convenient on the way home from work, picking up the children from school, or routine weekend errand route.

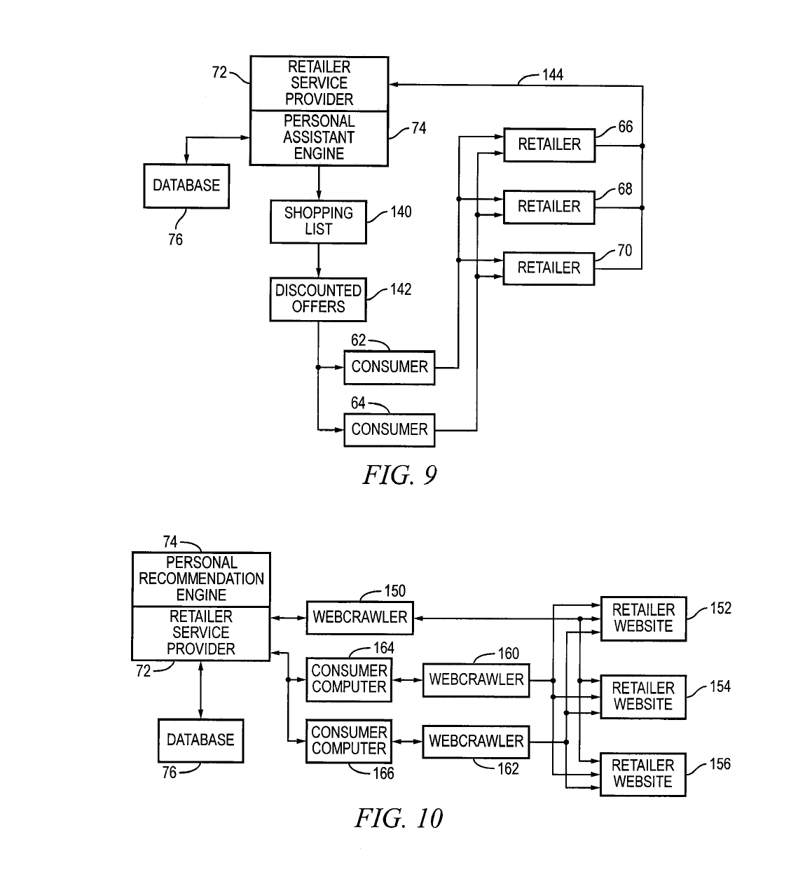

Personal assistant engine 74 stores the consumer-defined products and attributes from webpage 138 for future reference and updating. Personal assistant engine 74 can also store prices, product descriptions, names and locations of the retail stores selling the products, offer histories, purchase histories, as well as various rules, policies and algorithms in database 76. Personal assistant engine 74 generates shopping list 140 with weighted product attributes and discounted offers 142 for each specific consumer upon request, as shown in FIG. 9. The discounted offers 142 can include default discount offers and individualized discount offers. The individual products in shopping list 140 can be added or deleted and the weighted product attributes can be changed by the consumer. Shopping list 140 and discounted offers 142 are specific for each consumer and allow retailer service provider 72 to track specific products and preferred retailers selected by the consumer. Consumers 62 and 64 use shopping list 140 and discounted offers 142 to patronize retailers 66-70.

The consumer patronizes retailers 66-70, either in person or online, with shopping list 140 from personal assistant engine 74 in hand and makes purchasing decisions based on the recommendations on the shopping list. The consumers can rely on personal assistant engine 74 as having produced a comprehensive, reliable, and objective shopping list in view of the consumer's profile and weighted product preferences, as well as retailer product information, that will yield the optimal purchasing decision to the benefit of the consumer. In addition, the discounted price should be set to trigger the purchasing decision. Personal assistant engine 74 helps consumers quantify and develop confidence in making a good decision to purchase a particular product from a particular retailer. While the consumer makes the decision to place the product in the basket for purchase, he or she comes to rely upon, or at least consider, the recommendations from retailer service provider 72, i.e., shopping list 140 contributes to the tipping point for consumers to make the purchasing decision. The consumer model generated by personal assistant engine 74 thus in part controls many of the purchasing decisions and other aspects of commercial transactions within commerce system 60.

In order to store and maintain shopping list 140 for each consumer, personal assistant engine 74 must have access to up-to-date, comprehensive, reliable, and objective retailer product information. Retailer service provider 72 maintains database 76 with up-to-date, comprehensive, reliable, and objective retailer product information. The product information includes the product description, product attributes, regular retail pricing, and discounted offers. Retailer service provider 72 must actively and continuously gather up-to-date product information in order to maintain database 76. In one approach to gathering product information, retailers 66-70 may grant access to T-LOG data 46 for use by retailer service provider 72. T-LOG data 46 collected during consumer check-out can be sent electronically from retailers 66-70 to retailer service provider 72, as shown by communication link 144 in FIG. 9. Retailers 66-70 may be reluctant to grant access to T-LOG data 46, particularly without quid pro quo. However, as retailer service provider 72 gains acceptance and consumers 62-64 come to rely on the service to make purchasing decisions, retailers 66-70 will be motivated to participate.

Assuming one or more retailers 66-70 choose to grant access to T-LOG data 46, the retailers may also define a maximum retailer acceptable discounted price for each product that can be used by retailer service provider 72 to trigger a positive purchasing decision by consumers 62-64. The maximum retailer acceptable discounted price is typically determined by the retailer's profit margin. If product P costs $1.50 to manufacture, distribute, and sell, and the regular price is $2.50, then the retailer has at most $1.00 in profit to offer as a discount without creating an operating loss. In this case, the maximum retailer acceptable discounted price is $1.00 or less, depending on how much profit margin the retailer is willing to forego in order to make the sale.

One or more retailers 66-70 may decline to provide access to its T-LOG data for use with personal assistant engine 74. In such cases, retailer service provider 72 can exercise a number of alternative data gathering approaches and sources. In one embodiment, retailer service provider 72 utilizes computer-based webcrawlers or other searching software to access retailer websites for pricing and other product information. In FIG. 10, webcrawler 150 operates within the software of computer systems 82, 90, 94, or 100 used by retailer service provider 72. Retailer service provider 72 dispatches webcrawler 150 to make requests for product information from websites or portals 152, 154, and 156 of retailers 66, 68, and 70, respectively. Webcrawler 150 collects and returns the product information to personal assistant engine 74 for storage within database 76. For example, webcrawler 150 identifies products available from each of retailer websites 152-156 and requests pricing and other product information for each of the identified products. Webcrawler 150 navigates and parses each page of retailer websites 152-156 to locate pricing and other product information. The parsing operation involves identifying and recording product description, universal product code (UPC), price, ingredients, size, and other product information as recovered by webcrawler 150 from retailer websites 152-156. In particular, the parsing operation can identify discounted offers and special pricing from retailers 66-70. The product information from retailer websites 152-156 is sorted and stored in database 76.

Retailer service provider 72 can also dispatch webcrawlers 160 and 162 from computers 164 and 166 used by consumers 62-64, or from consumer cell phone 86, or other electronic communication device, to access and request product information from retailer websites or portals 152-156 or other electronic communication medium or access point. During the registration process of FIG. 6, retailer service provider 72 acquires the IP address of consumer computers 164 and 166, as well as the permission of the consumers to utilize the consumer computer and login to access retailer websites 152-156. Retailer service provider 72 causes webcrawlers 160-162 to be dispatched from consumer computers 164-166 and uses the consumer login to retailer websites 152-156 to access and request product information from retailers 66-70. Webcrawlers 160-162 collect the product information from retailer websites 152-156 through the consumer computer and login and return the product information to personal assistant engine 74 for storage within database 76. The execution of webcrawlers 160-162 from consumer computers 164-166 distributes the computational work.

For example, retailer service provider 72 initiates webcrawler 160 in the background of consumer computer 164 with a sufficiently low execution priority to avoid interfering with other tasks running on the computer. The consumer can also define the time of day and percent or amount of personal computer resources allocated to the webcrawler. The consumer can also define which retailer websites and products, e.g., by specific retailer, market, or geographic region, that can be accessed by the webcrawler using the personal computer resources. Webcrawler 160 executes from consumer computer 164 and uses the consumer's login to gain access to retailer websites 152-156. Alternatively, webcrawler 160 resides permanently on consumer computer 164 and runs periodically. Webcrawler 160 identifies products available from each of retailer websites 152-156 and requests pricing and other product information for each of the identified products. Webcrawler 160 navigates and parses each page of retailer websites 152-156 to locate pricing and other product information. The parsing operation involves identifying and recording product description, UPC, price, ingredients, size, and other product information as recovered by webcrawler 160 from retailer websites 152-156. In particular, the parsing operation can identify discounted offers and special pricing from retailers 66-70. The product information from retailer websites 152-156 is sorted and stored in database 76.

Likewise, webcrawler 162 uses consumer computer 166 and login to gain access to retailer websites 152-156. Webcrawler 162 identifies products available from each of retailer websites 152-156 and requests pricing and other product information for each of the identified products. Webcrawler 162 navigates and parses each page of retailer websites 152-156 to locate pricing and other product information. The parsing operation involves identifying and recording product description, UPC, price, ingredients, size, and other product information as recovered by webcrawler 162 from retailer websites 152-156. In particular, the parsing operation can identify discounted offers and special pricing from retailers 66-70. The product information from retailer websites 152-156 is sorted and stored in database 76. The product information requests to retailer websites 152-156 can be specific to the consumer's login. Retailers 66-70 are likely to accept product information requests from webcrawlers 160-162 because the requests originate from consumer computers 164-166 by way of the consumer login to retailer websites 152-156.

Retailer service provider 72 can also collect product information from discounted offers transmitted from retailers 66-70 directly to consumers 62-64, e.g., by email or cell phone 66. Consumer 62-64 can make the personalized discounted offers and other product information available to retailer service provider 72.

Retailers 66-70 have an interest in maximizing the profit from commercial transactions with consumers 62 and 64. Profit can be expressed as unit sales of products (US) times price less cost per unit of product, as given in equation (1).

Profit=US*(price-cost) (1)

Costs are typically fixed or at least predictable in terms of inventory, raw materials, labor, facilities, equipment, taxes, and other overhead expenses. In addition, costs are similar between competing retailers with some variation for efficiency of operation and volume discounts from distributor 36. The price and demand are principal factors in determining profit. In most cases, price is inversely related to demand, as shown in price-demand curve 170 of FIG. 11. In demand curve 170 for a given product P, as price increases, unit sales decrease and, conversely, as price decreases, unit sales increase. Price elasticity of demand is a unitless measure of response in demand to changes in price, i.e., a ratio involving the percent change in demand to the percent change in price. At price point PP1, the unit sales are US1. The revenue attained by the retailer is given as PP1*US1. At price point PP2, the unit sales are US2. The revenue attained by the retailer is given as PP2*US2. If PP2 is less than PP1, then US2 is greater than US1.

In one embodiment, unit sales US can be expressed in exponential form as given in equation (2).

US(p)=Q₀*exp(−βₚ) (2)

where:
Q₀ is a baseline demand
β is price elasticity of demand
p is price

Profit can be optimized by determining the maximum or peak of the function where the slope is zero. The maximum of the function can be determined by substituting equation (2) into equation (1), taking the derivative of equation (1) with respect to price, and setting the function equal to zero. The profit optimization reduces to equation (3) as a relationship between price, costs, and price elasticity of demand.

price=cost+1/β (3)

Assuming cost is fixed or predictable, equation (3) relates price to the inverse of price elasticity of demand. Retailer service provider 72 can determine price for a given product and retailer directly from T-LOG data 46. Retailer service provider 72 accumulates T-LOG data 46 in database 76 from retailers 66-70 as part of the comparative shopping service provided to consumers 62-64. Alternatively, retailer service provider 72 determines price for a given product and retailer through webcrawlers 150, 160, and 162, as described in FIG. 10.

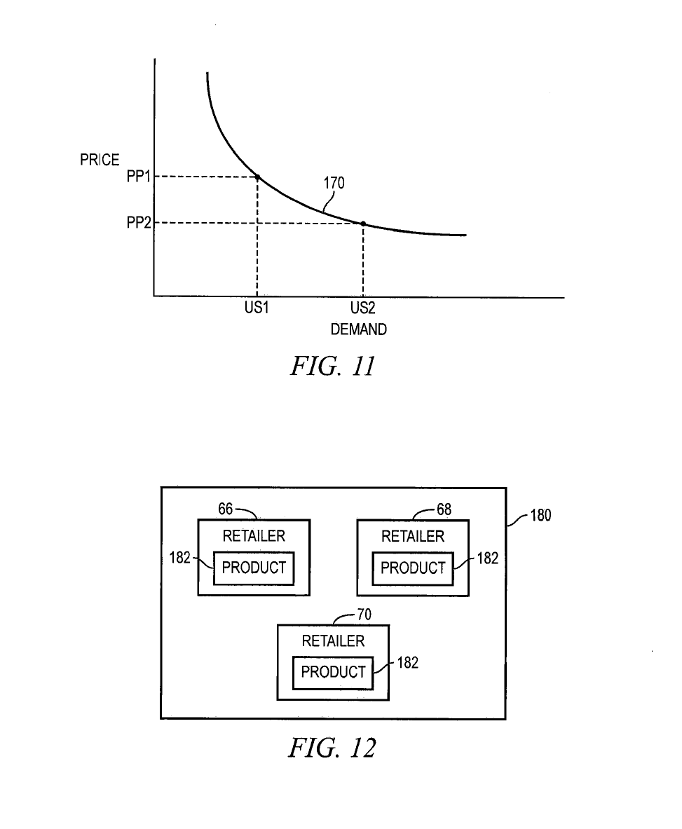

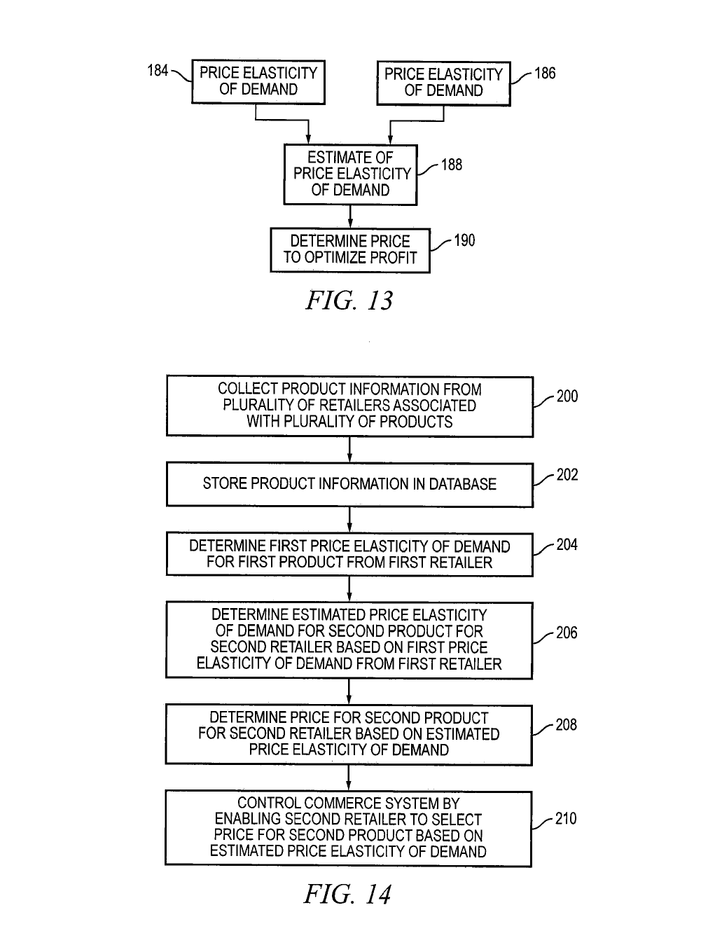

FIG. 12 shows retailers 66 and 68 operating in local market 180 for an extended period of time. Retailer 66 and 68 each offer product 182 to consumers 62-64 and have accumulated sales over the extended period of time. Retailer 66 and 68 each have a price and cost associated with product 182. The cost of product 182 is substantially the same for retailers 66 and 68 as each retailer pays a similar cost for product 182 to distributor 36 in local market 180. Retailers 66 and 68 have similar costs for raw materials, labor, facilities, equipment, taxes, and other overhead expenses. By equation (3), retailer service provider 72 can determine price elasticity of demand associated with product 182 for retailers 66 and 68. In FIG. 13, block 184 represents price elasticity of demand for product 182 of retailer 66, and block 186 represents price elasticity of demand for product 182 of retailer 68.

Retailer 70 decides to open a store in local market 180 and offer product 182, or product similar to product 182, to consumers 62-64. Alternatively, retailer 70 decides to add product 182, or product similar to product 182, to an existing store in local market 180. Retailer 70 may have price and demand information for product 182 in markets other than local market 180, e.g. nationwide data or other regional data, but what is more relevant here is access to price and demand information in local market 180. At least in the short term, retailer 70 has limited or no price and demand information from which to determine price elasticity of demand in local market 180. To assist retailer 70 in maximizing profit for product 182, retailer service provider 72 uses the price elasticity of demand for retailer 66 and/or retailer 68 as an estimate of the price elasticity of demand for product 182 for retailer 70, as shown in block 188 of FIG. 13. The price elasticity of demand for the same or similar product is approximately equal for similarly situated retailers operating in the same or similar market, i.e., local market 180. That is, the estimate of price elasticity of demand for retailer 70 is determined to be approximately the same as the price elasticity of demand for retailer 68 or retailer 68 in local market 180. In another embodiment, the estimate of price elasticity of demand for retailer 70 is determined to be proportional, based on relative attributes between the retailers, to the price elasticity of demand for retailer 68 or retailer 68 in local market 180. Accordingly, the estimate of price elasticity of demand for retailer 70 based on the price elasticity of demand of retailer 66 or retailer 68 is generally valid at least for local market 180.

In another embodiment, retailer service provider 72 uses an average or mean price elasticity of demand for retailers 66-68 for the estimate of price elasticity of demand for retailer 70. The average price elasticity of demand for retailers 66-68 can be weighted based on similar attributes of retailers 66-70. The weighted average can be based on total volume of sales for each retailer, proximity to consumer traffic patterns, union or non-union labor, automation of store operations, age of facilities, and national presence of the retailers. For example, if retailer 66 has similar total volume sales and nationwide presence as retailer 70, while retailer 68 has lower total volume of sales than retailer 70 and only local presence, then the price elasticity of demand for retailer 66 is weighted more than the price elasticity of demand for retailer 68 in determining an average or mean for the estimate of price elasticity of demand for retailer 70.

Given the estimate price elasticity of demand β_{EST} for retailer 70, a price for product 182 can be selected for retailer 70 in equation (4). In block 190, retailer 70 can use the estimate price elasticity of demand β_{EST} to determine a price for product 182 that optimizes or maximizes profit for the product without prior price and demand data. The cost of product 182 is substantially the same for retailer 70 as retailers 66 and 68 because each retailer pays a similar cost for product 182 to distributor 36. Retailers 66-70 have similar costs for raw materials, labor, facilities, equipment, taxes, and other overhead expenses.

price=cost+1/β_{EST} (4)

Retailer 70 can use the estimate price elasticity of demand β_{EST} to select a price for product 182 that optimizes or maximizes profit for the product in local market 180 without prior price and demand data. Notably, the estimate price elasticity of demand β_{EST} has been determined from pricing information associated with product 182 from retailers 66-68, but without direct demand data for product 182 from retailers 66-68. The estimate price elasticity of demand β_{EST} is based on the approximation that retailers 66-70 have similar price elasticity of demand for the same or similar products. Retailer 70 offers product 182 to consumers 62-64 with a price based on the estimate price elasticity of demand β_{EST}. Retailer service provider 72 in part controls commerce system 30 by enabling retailer 70 to estimate price elasticity of demand for product 182 based on the price elasticity of demand for the same or similar product offered by retailers 66-68 in local market 180. Consumers 62-64 purchase products from retailer 70 in local market 180, which drives activities of other members of commerce system 30. The price for product 182 can be selected from the estimate price elasticity of demand β_{EST} to optimize or maximize the profit for the product.

As retailer 70 gains price and demand data for actual sales of product 182 in local market 180, the estimate price elasticity of demand β_{EST} can be revised by blending actual price and demand data of retailer 70 with the estimated price elasticity of demand from retailers 66-68 using a Bayesian framework. In general, Bayes Rule in equation (5) can be used to update the estimate price elasticity of demand as actual price and demand data becomes available. A Bayesian inference derives the posterior probability from a prior probability P(H), likelihood function P(E|H), and marginal likelihood function P(E) for the data to be observed.

$$P ( H \vert E ) = \frac{P ( E \vert H ) \cdot P ( H )}{P ( E )} \qquad ( 5 )$$

where:
H is the estimate price elasticity of demand from retailers 66-68
E is actual price and demand data from sales of product 182 by retailer 70
P(H|E) is the posterior probability of H after E is observed
P(E|H) is the likelihood of E given H
P(H) is the prior probability of H before E is observed
P(E) is the marginal likelihood of E

Retailer service provider 72 can also provide an estimate of cross price elasticity of demand to retailer 70 based on the cross price elasticity of demand from retailer 66-68. Cross price elasticity of demand measures the percentage change in demand for a particular product caused by a percent change in the price of another substitute or related product. For example, if retailer 66 lowers the price of instant oatmeal, then the demand for regular uncooked oatmeal will decrease according to the cross price elasticity of demand.

Using the estimated price elasticity of demand β_{EST} to optimize or maximize the profit for a product or service is applicable to other types of commerce systems, e.g. financial, investments, banking, manufacturing, distribution, medical, transportation, entertainment, hospitality, and service vendors and providers, just to name a few. In each case, the estimated price elasticity of demand β_{EST} for a first market participant is determined based on the actual price elasticity of demand for other market participants in the local market. With the estimated price elasticity of demand β_{EST}, the first market participant can determined price for the product or service to optimize profit in the local market, as described above. In some cases, the local market concept can be expanded to a larger scale, e.g., the local market can be a regional market as compared to the national market, or a national market as compared to the world-wide market. In other cases, the market can be based on the national market or world-wide market.

FIG. 14 illustrates a process for controlling a commerce system by enabling the retailer to estimate price elasticity of demand for a product based on the price elasticity of demand for the same or similar product offered by other retailers in a local market. In step 200, product information is collected from a plurality of retailers associated with a plurality of products. In step 202, the product information is stored in a database. In step 204, a first price elasticity of demand is determined for a first product from a first retailer. In step 206, an estimated price elasticity of demand is determined for a second product for a second retailer based on the first price elasticity of demand from the first retailer. The estimated price elasticity of demand is substantially equal to the first price elasticity of demand. A second price elasticity of demand is determined for a third product from a third retailer. The estimated price elasticity of demand is determined for the second product for the second retailer based on average or mean, or weighted average or mean, of the first price elasticity of demand and second price elasticity of demand. In step 208, a price is determined for the second product for the second retailer based on the estimated price elasticity of demand. A profit for the second product is optimized for the second retailer by selecting the price for the second product based on the estimated price elasticity of demand. In step 210, the commerce system is controlled by enabling the second retailer to select the price for the second product based on the estimated price elasticity of demand. The estimated price elasticity of demand is revised for the second product for the second retailer as a blend of the first price elasticity of demand and actual prices and demand of the product from the second retailer.

In summary, the retailer service provider in part controls the movement of goods between members of the commerce system. Retailers offer products for sale. Consumers make decisions to purchase the products. Retailer service provider 72 offers consumers comparative shopping services, to aid the consumer in making purchasing decisions. In particular, retailer service provider 72 collects product information associated with a plurality of products. The product information can be receiving the product information from a retailer in the form of transactional data or retrieved from a retailer website. Retailer service provider 72 determines a price elasticity of demand for a first product from a first retailer and determines an estimated price elasticity of demand for a second product for a second retailer based on the first price elasticity of demand from the first retailer. The second retailer can select a price for the second product based on the estimated price elasticity of demand. A profit for the second product is optimized for the second retailer by selecting the price for the second product based on the estimated price elasticity of demand. The consumer makes purchases within the commerce system based on the shopping list and product information compiled by the retailer service provider, as well as the price selected by the second retailer based on the estimated price elasticity of demand. By following the recommendations from the retailer service provider, the consumer can receive the most value for the money. The retailer can optimize profit for the second product by selecting the price for the second product based on the estimated price elasticity of demand.

While one or more embodiments of the present invention have been illustrated in detail, the skilled artisan will appreciate that modifications and adaptations to those embodiments may be made without departing from the scope of the present invention as set forth in the following claims.

What is claimed:

1. A method of controlling a commerce system, comprising:
collecting product information from a plurality of retailers associated with a plurality of products;
storing the product information in a database;
determining a first price elasticity of demand for a first product from a first retailer;
determining an estimated price elasticity of demand for a second product for a second retailer based on the first price elasticity of demand from the first retailer;
determining a price for the second product for the second retailer based on the estimated price elasticity of demand; and
controlling the commerce system by enabling the second retailer to select the price for the second product based on the estimated price elasticity of demand.

2. The method of claim 1, further including optimizing profit for the second product for the second retailer by selecting the price for the second product based on the estimated price elasticity of demand.

3. The method of claim 1, wherein the estimated price elasticity of demand is substantially equal to the first price elasticity of demand.

4. The method of claim 1, further including:
determining a second price elasticity of demand for a third product from a third retailer; and
determining the estimated price elasticity of demand for the second product for the second retailer based on average or mean of the first price elasticity of demand and second price elasticity of demand.

5. The method of claim 4, further including weighting the average or mean of the first price elasticity and second price elasticity based on attributes of the first retailer and third retailer.

6. The method of claim 1, further including revising the estimated price elasticity of demand for the second product for the second retailer as a blend of the first price elasticity of demand and actual prices and demand from the second retailer.

7. A method of controlling a commerce system, comprising:
collecting product information associated with a plurality of products;
determining a first price elasticity for a first product from a first member of the commerce system;
determining an estimated price elasticity for a second product for a second member of the commerce system based on the first price elasticity from the first member; and
determining a price for the second product for the second member based on the estimated price elasticity.

8. The method of claim 7, further including controlling the commerce system by enabling the second member to select the price for the second product based on the estimated price elasticity.

9. The method of claim 7, further including optimizing profit for the second product for the second member by selecting the price for the second product based on the estimated price elasticity.

10. The method of claim 7, wherein the estimated price elasticity is substantially equal to the first price elasticity.

11. The method of claim 7, further including:
determining a second price elasticity for a third product from a third member of the commerce system; and
determining the estimated price elasticity for the second product for the second member based on average or mean of the first price elasticity and second price elasticity.

12. The method of claim 11, further including weighting the average or mean of the first price elasticity and second price elasticity based on attributes of the first member and third member.

13. The method of claim 7, further including revising the estimated price elasticity for the second product for the second member as a blend of the first price elasticity and actual prices and demand of the second product from the second member.

14. A method of controlling a commerce system, comprising:
determining a first price elasticity for a first product from a first member of the commerce system; and
determining an estimated price elasticity for a second product for a second member of the commerce system based on the first price elasticity from the first member.

15. The method of claim 14, further including determining a price for the second product for the second member based on the estimated price elasticity.

16. The method of claim 14, further including controlling the commerce system by enabling the second member to select the price for the second product based on the estimated price elasticity.

17. The method of claim 14, further including optimizing profit for the second product for the second member by selecting the price for the second product based on the estimated price elasticity.

18. The method of claim 14, wherein the estimated price elasticity is substantially equal to the first price elasticity.

19. The method of claim 14, further including:
determining a second price elasticity for a third product from a third member of the commerce system; and
determining the estimated price elasticity for the second product for the second member based on average or mean of the first price elasticity and second price elasticity.

20. The method of claim 14, further including revising the estimated price elasticity for the second product for the second member as a blend of the first price elasticity and actual prices and demand of the second product from the second member.

21. A computer program product usable with a programmable computer processor having a computer readable program code embodied in a tangible computer usable medium for controlling a commerce system, comprising:
determining a first price elasticity for a first product from a first member of the commerce system; and
determining an estimated price elasticity for a second product for a second member of the commerce system based on the first price elasticity from the first member.

22. The computer program product of claim 21, further including determining a price for the second product for the second member based on the estimated price elasticity.

23. The computer program product of claim 21, further including optimizing profit for the second product for the second member by selecting the price for the second product based on the estimated price elasticity.

24. The computer program product of claim 21, wherein the estimated price elasticity is substantially equal to the first price elasticity.

25. The computer program product of claim 21, further including revising the estimated price elasticity for the second product for the second member as a blend of the first price elasticity and actual prices and demand of the second product from the second member.
